(19) United States
(12) Patent Application Publication
(10) Pub. No.: US 2019/0360943 A1
(43) Pub. Date: Nov. 28, 2019

(54) DETECTION OF MICRO-CRACKS IN COATINGS

(71) Applicant: ALTRIA CLIENT SERVICES LLC, Richmond, VA (US)

(72) Inventors: Amrita SAHU, Richmond, VA (US); Henry M. DANTE, Midlothian, VA (US); Christopher HESSION, Mechanicsville, VA (US); James E. FRANKE, Midlothian, VA (US); Ujwala WAREK, Richmond, VA (US)

(21) Appl. No.: 15/989,685

(22) Filed: May 25, 2018

(51) Int. Cl. G01N 21/90; G01N 21/88

(52) U.S. Cl. CPC G01N 21/90; G01N 21/64; G01N 21/8806

(57) ABSTRACT

A method of inspecting for micro-cracks in a coated piece that includes a substrate and a coating, the method comprising generating a responsive spectral response from an area of inspection of the coated piece by irradiating at least a portion of the coated piece, the area of inspection being less than a predetermined nominal dimension of a micro-crack, and analyzing the responsive spectral response to determine whether a micro-crack exists in the coating, including by comparing the responsive spectral response to one or more predetermined spectral values to determine whether the responsive spectral response corresponds to a response associated with a substrate such as the substrate in the coated piece.

### FIELD

The disclosure relates generally to detection of flaws in coatings and more particularly to detection of microscopic flaws in coatings on metal.

### ENVIRONMENT

A variety of metal packaging containers and their components may be constructed from a metal substrate to which may be applied a barrier layer for purposes of preventing interaction between the contained product and the metal substrate. Imperfections in the barrier layer and an availability of moisture and/or salts from the contained product may support an unwelcome oxidation of the metal substrate. Rust spots may detract from the appearance of the container when opened and may negatively impact a consumer's perception of the contained product.

### SUMMARY

An aspect of certain embodiments of the present disclosure provides a method of inspecting for micro-cracks in a coated piece that includes a substrate and a coating, the method comprising generating a responsive spectral response from an area of inspection of the coated piece by irradiating at least a portion of the coated piece, the area of inspection being less than a predetermined nominal dimension of a micro-crack, and analyzing the responsive spectral response to determine whether a micro-crack exists in the coating, including by comparing the responsive spectral response to one or more predetermined spectral values to determine whether the responsive spectral response corresponds to a response associated with a substrate such as the substrate in the coated piece.

In embodiments, the spectral responses may be at least one of a fluorescent response, a reflective response, a multi-spectral response and a hyperspectral response.

In some embodiments, the method may include analyzing the responsive spectral response to determine whether a thinned condition of the coating exists by comparing the responsive spectral response to one or more predetermined spectral values corresponding to a thinned condition of the coating.

Another aspect of certain embodiments of the present disclosure provides a method of detecting micro-cracks in a coated piece comprising a coating and a substrate, the method comprising irradiating at least a portion of the coated piece with an excitation radiation having a capacity to cause the coating to undergo a fluorescent spectral response, and to cause the substrate to undergo a lesser second fluorescent spectral response when the substrate is irradiated upon a portion where the substrate is exposed to the excitation radiation by a presence of a micro-crack in the coating, measuring a fluorescent spectral response from the coated piece in a selected area of inspection, and analyzing the measured fluorescent spectral response to determine whether a micro-crack exists in the coating, including by comparing the measured fluorescent spectral response to one or more predetermined values to determine whether the response corresponds to a response associated with a substrate such as the substrate in the coated piece.

Yet another aspect of certain embodiments of the present disclosure provides a method of inspecting a coated metallic container component, the coated metallic container component comprising a metallic substrate and a protective coating, the method comprising irradiating at least a portion of the coated component with a selected radiation having a capacity to cause the coating to undergo a first spectral response, and to cause the substrate to undergo a lesser second spectral response when the substrate is irradiated upon a portion where the substrate is exposed to the radiation by a presence of a micro-flaw in the coating of sufficient depth to establish a breach in the protective layer, measuring a spectral response from the coated component in a selected area of inspection; and analyzing the measured spectral response to determine whether a micro-flaw exists of sufficient depth to establish a breach in the protective layer, including by determining that the measured spectral response falls below a predetermined threshold.

### BRIEF DESCRIPTION OF THE DRAWINGS

The forms disclosed herein are illustrated by way of example, and not by way of limitation, in the figures of the accompanying drawings and in which like reference numerals refer to similar elements and in which:

FIG. 1A is a perspective view of an example embodiment of a coated substrate such as a metal lid component of a container for tobacco, which may be spectrally inspected for micro-cracks in accordance with an example method of the disclosure, according to an example embodiment;

FIG. 1B is a cross-sectional side view at a location X on the coated substrate shown in FIG. 1A;

FIG. 10 is a cross-sectional side view at the location X on the coated substrate shown in FIG. 1A after a sufficient period of time has passed for a rust spot to appear;

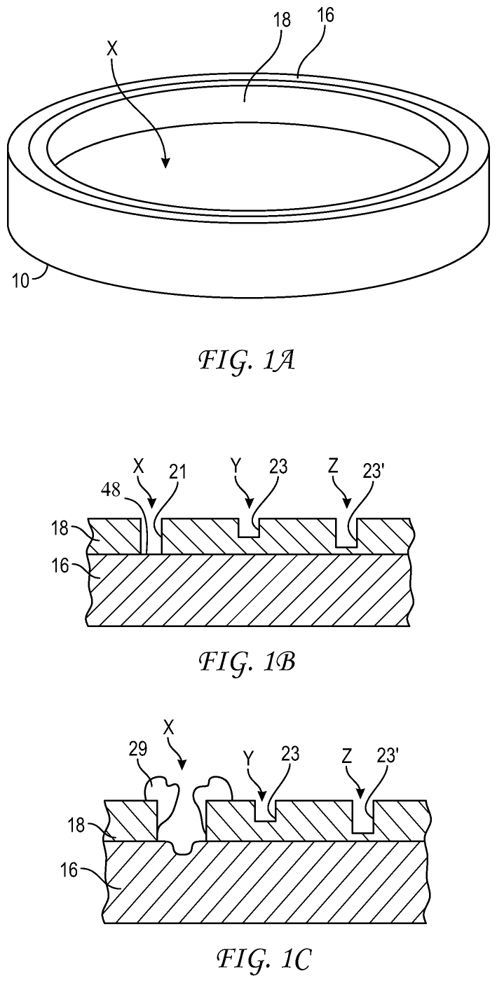

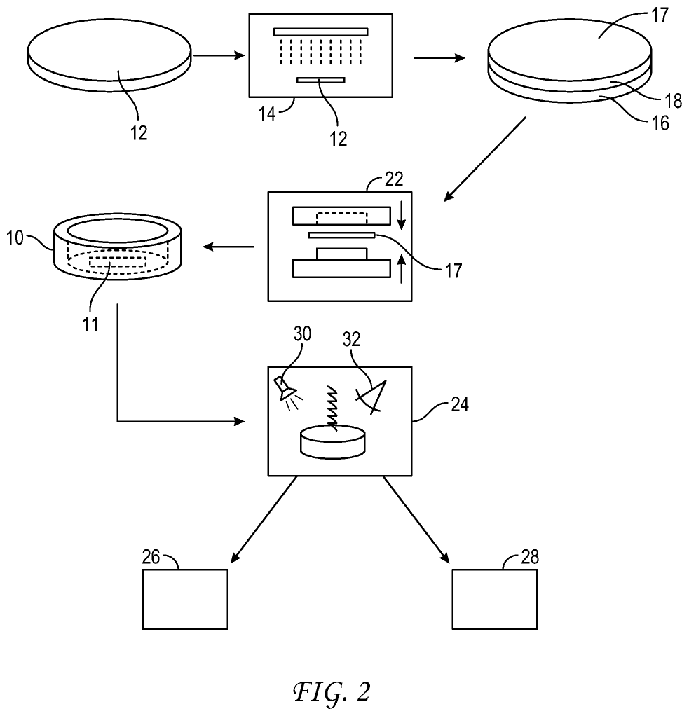

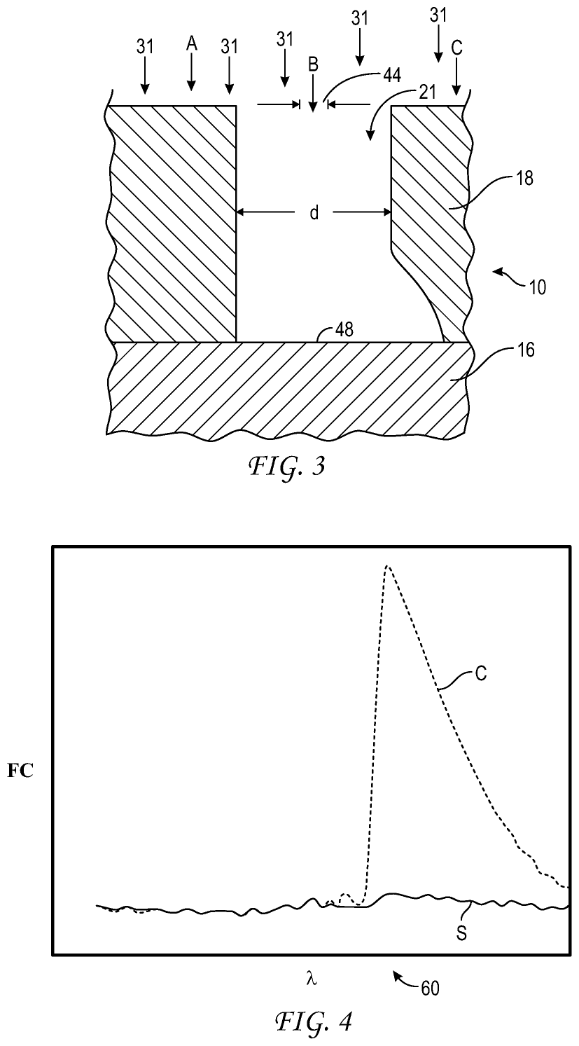

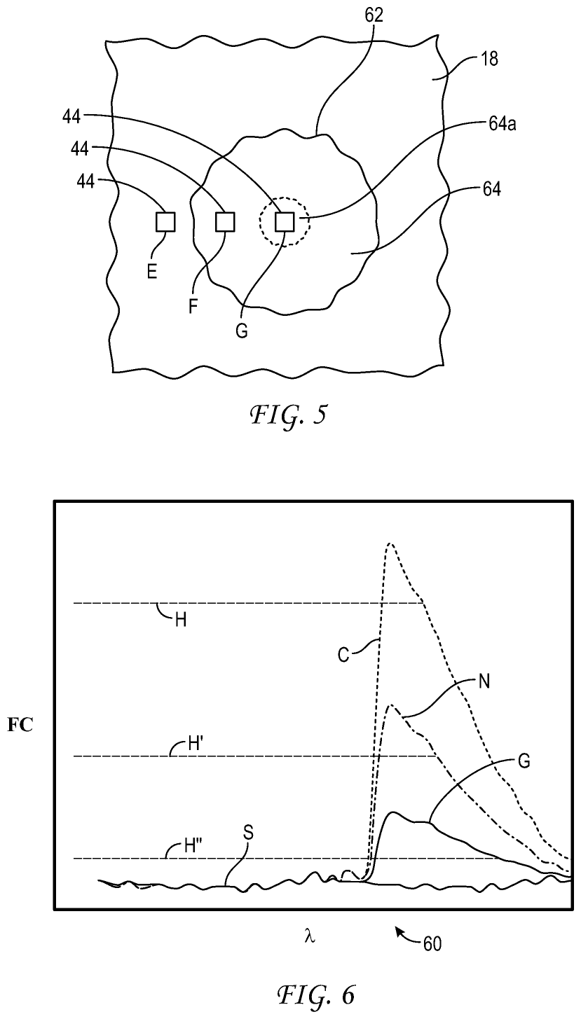

FIG. 2 is a schematic representation of an example method of making the coated substrate of FIG. 1A, according to an example embodiment;

FIG. 3 is an enlarged cross-sectional side view of a micro-crack in a coated substrate such as shown in FIG. 1A, according to an example embodiment;

FIG. 4 is a graphical representation of detected fluorescent response (FC) versus wavelength (A) of the spectral response from a spectral inspection of a region about a micro-crack shown in FIG. 3, according to an example embodiment;

FIG. 5 is a top planar representation of a minute flaw and certain aspects of its inspection, according to an example embodiment;

FIG. 6 is a graphical representation of detected fluorescence response (FC) versus wavelength (A) of the spectral response from a spectral inspection of the minute flaw represented in FIG. 5, according to an example embodiment; and

FIG. 7 is a schematic of an example embodiment of a micro-spectrophotometer configured to analyze a fluorescent spectral response according to an example embodiment.

### DETAILED DESCRIPTION

Each of the following terms: “includes,” “including,” “has,” “‘having,” “comprises,” and “comprising,” and, their linguistic or grammatical variants, derivatives, and/or conjugates, as used herein, means “including, but not limited to.”

Throughout the illustrative description, the examples, and the appended claims, a numerical value of a parameter, feature, object, or dimension, may be stated or described in terms of a numerical range format. It is to be fully understood that the stated numerical range format is provided for illustrating implementation of the forms disclosed herein, and is not to be understood or construed as inflexibly limiting the scope of the forms disclosed herein.

Moreover, for stating or describing a numerical range, the phrase “in a range of between about a first numerical value and about a second numerical value,” is considered equivalent to, and means the same as, the phrase “in a range of from about a first numerical value to about a second numerical value,” and, thus, the two equivalently meaning phrases may be used interchangeably.

It is to be understood that the various forms disclosed herein are not limited in their application to the details of the order or sequence, and number, of steps or procedures, and sub-steps or sub-procedures, of operation or implementation of forms of the method or to the details of type, composition, construction, arrangement, order and number of the system, system sub-units, devices, assemblies, sub-assemblies, mechanisms, structures, components, elements, and configurations, and, peripheral equipment, utilities, accessories, and materials of forms of the system, set forth in the following illustrative description, accompanying drawings, and examples, unless otherwise specifically stated herein. The apparatus, systems and methods disclosed herein can be practiced or implemented according to various other alternative forms and in various other alternative ways.

It is also to be understood that all technical and scientific words, terms, and/or phrases, used herein throughout the present disclosure have either the identical or similar meaning as commonly understood by one of ordinary skill in the art, unless otherwise specifically defined or stated herein. Phraseology, terminology, and, notation, employed herein throughout the present disclosure are for the purpose of description and should not be regarded as limiting.

The present disclosure provides embodiments of methods of inspecting a coating of a coated substrate for micro-cracks. Other techniques for detection of minute flaws have included techniques in which a sample specimen of the coated substrate would be immersed in a bath of salted water for an extended period of time. A resolution of whether there may be a presence or absence of a minute flaw would be determined by a visual inspection for the appearance of rust spots over time. Such techniques were destructive of the specimen and required a significant expenditure of time. Other techniques have relied upon an addition of a fluorescing agent to a portion of the coated substrate structure, which may be invasive and destructive of the originally intended (unaltered) structure and the originally intended (unaltered) composition of the coated substrate.

Referring to FIG. 1A, the disclosure provides various embodiments of a method of spectrally inspecting a coated component (coated piece) 10 for micro-cracks, which may be done in a manner that is non-invasive and non-destructive in certain embodiments. In an example embodiment, the coated component 10 may comprise a substrate 16 and a layer (coating) 18. In some embodiments, the coating 18 may serve as a barrier to protect the substrate 16 against contact with moisture, salts or other agents which might, over time, cause the substrate 16 to oxidize. In some embodiments, the coated component 10 may be suited for use as a cup-shaped lid component and/or a base component of a metal container for containing tobacco products such as loose moist snuff tobacco, snus, pouched tobacco, pipe tobacco and others. However, it is contemplated that other shapes, applications, constructions and materials of a coated component 10 may be utilized in the practice of the teachings herein.

Referring now to FIG. 2, in an example embodiment, the coated component 10 may be manufactured by directing an uncoated piece 12 through an applicator station 14 which may apply a coating 18 upon one or both surfaces of the piece 12 to form a blank 17 which may comprise the substrate 16 and at least one coating (layer) 18. The coating 18 may be disposed along one side of the substrate 16 or both. The coated blank 17 may then be directed through a forming station 22, which may form the blank 17 into the desired form of the cup-shaped coated, component 10 (or other shape or component, if desired). In some embodiments, the coated component 10 may include embossed indicia 11, which may be formed by embossing a selected region of the coated component 10. Thereafter, the coated component 10 may be directed to an inspection station 24 for inspecting the coated component 10 for micro-flaws in the form of micro-cracks 21 (shown in FIG. 1B), wherein an inspection can be conducted in accordance with the teachings which follow. It is noted that the finished coated component 10 is but one example of a host of possible coated components (coated substrates) to which the teachings may be applied. In the teachings herein, the terms “coated component” and “coated substrate” may be used interchangeably.

In some embodiments, the output of the inspection station 24 may be utilized in a redesign 26 of the form of the coated component 10 and/or in a redesign 26 of aspects of the above described manufacturing process; and/or the output of the inspection station 24 may be utilized in quality control 28 to remove from a supply of coated components 10 those which exhibit a presence of micro-cracks 21 as detected by the inspection station 24. An inspection may be conducted upon only a sample number of coated components 10 of a population of newly produced coated components 10 or upon each coated component 10 of the population.

In certain embodiments, a substrate 16 may be constructed from a metal or a metal composite or a metal alloy such as steel and the (barrier) layer 18 may comprise an organic coating, such as a coating constructed from phenolic resins, epoxies, polymers, or combinations thereof. In some example embodiments, the barrier layer 18 may be applied to one or more surfaces of the metal (metallic) substrate 16 as an aqueous or solvent-based solution, which may be dried or baked to cure. In some other embodiments, the barrier layer 18 may be constructed from a polymeric film such as a polyester terephthalate (PET) film, a polypropylene (PP) film, or other suitable polymeric film. In some embodiments, the barrier layer 18 may be applied to the metallic substrate 16 as a thin polymeric sheet, which may be applied against and then bonded to a surface of the metal substrate 16. In some embodiments, the layer 18 may comprise an enamel coating.

In reference to the example embodiment shown in FIG. 2, during the application of a barrier layer 18 upon the substrate 16 at the applicator station 14 and/or during operation of the forming station 22, it is possible for microscopic flaws (including micro-cracks 21) to occur in the coating 18 due to inconsistencies in the application process and/or the tendency of the stamping and/or embossing operations of the forming operation to impose stress upon the coating 18. Handling of the coated component 10 during manufacture and in transportation may also contribute to micro-cracking. Different types of coatings may have different mechanical properties, some of which may be less flexible and more prone to micro-cracking than others. Forming the coated metal into the desired utilitarian shape (e.g., a can lid) and embossing decorative features may impose stress upon the substrate and the coating, which may lead to creation of micro-cracks in the coating 18.

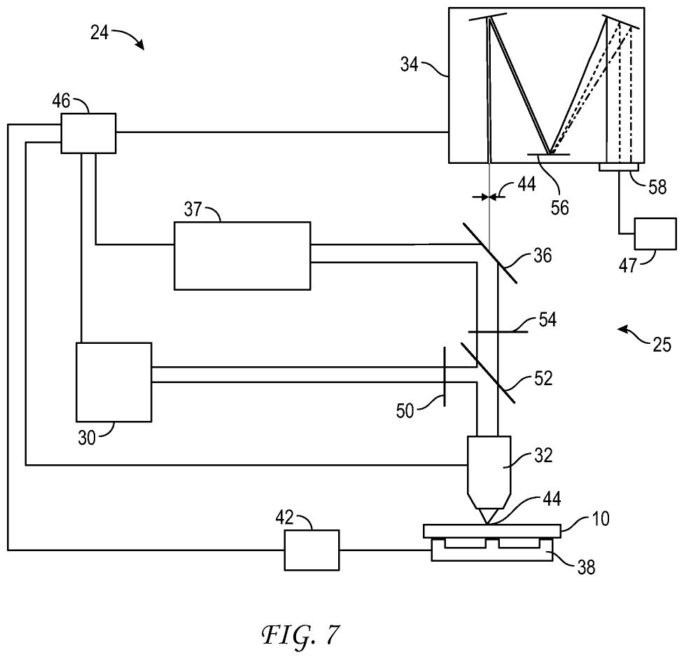

Referring now to FIGS. 1B and 10, micro-cracks 21 such as those portrayed at a location X of the coated component 10 may be undetectable to the human unaided eye and may be difficult to detect even with the assistance of some magnification. Some micro-cracks 21, such as represented at the location X, may extend entirely through and breach the barrier layer 18 and may expose a surface portion 48 of the substrate 16 to its surrounding environment.

FIG. 10 provides a representation of what may occur at the location X over a period time in which the coated component 10 may have served as part of a closed container of a material such as tobacco. During such time and with the presence of a micro-crack 21, the substrate 16 of the coated component 10 may come into contact with or otherwise interact with water, salts and other ingredients of the contained (tobacco) material. Over time, the breach may widen (and may become macro-sized) and some oxidized material 29 might collect about the location X, which may be in the form of an unsightly, visible spot.

Still referring to FIGS. 1B and 10, at times, the coated component 10 may also exhibit some minute flaws (micro-flaws) 23, such as at a location Y, of a generally similar size of the aforementioned micro-cracks 21, but which may only extend partially into the barrier layer 18 and therefore may not breach the barrier layer 18 nor expose the substrate 16 to oxidation as previously described. Similarly, at times, the coated component 10 may also exhibit deeper minute flaws 23′ such as shown at a location Z, which extend closer to the substrate 16, but yet may not constitute a breach of the barrier layer 18. Some embodiments may have a capacity to discern between a breaching micro-crack 21, which may present an issue such as previously described, from non-breaching minute flaws 23, 23′, which may not present such problems.

It is noted that although the micro-crack 21 and the micro-flaws 23, 23′ are shown in FIGS. 1B and 10 as being regular in shape and form, it is to understood that the aforementioned may actually be highly irregular in shape and form.

Referring now to FIGS. 2 and 7, in an embodiment, the inspection station 24 may comprise a UV-visible-NIR microscope objective 32, a source of excitation radiation 30, which may be in communication with the microscope objective 32 and a spectral analyzer 34 which may be arranged to receive an output from the microscope objective 32 through a mirrored aperture 36. The mirrored aperture 36 may be used to determine the size of the area of inspection 44. In some embodiments, the inspection station 24 may further comprise a high-resolution digital image generator 37 for purposes of facilitating manual focusing of the microscope objective 32, when desired, and/or to provide imagery for human interface such as upon a screen monitor. The inspection station 24 may further comprise a stage (support) 38 for presenting a specimen of a coated component 10 (and/or the coated blank 17) to the microscope objective 32 for inspection.

In some embodiments, the support 38 may be movable by a suitable drive mechanism 42 to move a specimen either continuously, intermittently, or singularly into and out of position with respect to the microscope objective 32. The drive mechanism 42 may also be configured to adjust the position of a specimen relative to the objective 32 incrementally at the command of the operator or automatically so that an area of inspection 44 may be moved along a particular region of the specimen or throughout an entire extent of the specimen surface or in accordance with a predetermined pattern. A suitable controller or controllers 46 may be linked to one or more of the aforementioned components to control and coordinate execution their respective functionalities, and the analyzer 34 may include a link to a suitable logic processor 47 to execute algorithms based upon quantified differences in spectral signatures (responses) between the substrate 16 (e.g., metal) and the coating 18 to indicate whether a microscopic crack (micro-crack) 21 is present in or absent from the coating 18 at the area of inspection 44.

Referring in particular to FIG. 7, in some embodiments, the inspection station 24 may comprise a florescent micro-spectrometer 24 which may employ an excitation filter 50 and a dichroic filter 52 along a pathway of communication between the light source 30 and the microscope objective 32, and may further provide a barrier filter 54 and the mirrored aperture 36 along a pathway of communication between the microscope objective 32 and the spectral analyzer 34. The spectral analyzer 34 may comprise a suitable holographic grating 56 and detector 58 such as a charge-coupled device. A practice of the teachings herein can employ components and layouts of a suitable micro-spectrometer other than what is specifically shown and described herein.

Referring now also to FIG. 3, the inspection station 24 of an example embodiment may be arranged to irradiate a target portion of a coated component 10 with an excitation radiation 31. In some embodiments, the target portion of the coated component 10 may be larger in area than a typical micro-crack 21. In the presence of a micro-crack 21, at least a portion of the excitation radiation 31 may be communicated to an exposed portion 48 of the substrate 16 such that the exposed portion 48 of the substrate 16 is caused to spectrally respond differently than the coating 18. In some embodiments, the excitation radiation 31 may cause the substrate 16 to fluoresce to a lesser extent than the coating 18 (or not at all), which response is communicated to the analyzer 34. By analyzing only a limited inspection area 44 at a time, as may be determined by the selected size of a mirrored aperture 36, a micro-crack 21 may be detected and a remedial action applied. In some embodiments, the area of inspection 44 may have a width less than a nominal dimension d of a micro-crack 21, as may be established from historical inspections of flawed sample coated components 10, and the inspection area 44 may be only a fraction of the nominal dimension d of the micro-crack 21. In some embodiments, the area of inspection 44 may have a width that is equal to or greater than a nominal dimension d of a micro-crack 21.

In some embodiments, the excitation radiation 31 may be selected to excite a measurable change in spectral (fluorescent) response solely from the coating 18, with an absence of a measurable change in spectral (fluorescent) response from the substrate 16 across a range (spectrum) of wavelength analyzed by the analyzer 34. In an embodiment wherein the coating comprises an organic coating as previously described, and the substrate is constructed of a metal, the analyzer 34 may operate in spectrum in range of ultraviolet, visible, near infra-red light, such as by way of non-limiting examples, in the range of about 250 to about 900 nanometer (nm) wavelength or in the range of about 400 to about 800 nm wavelength at which the polymeric material of the coating 18 may be known to exhibit strong fluorescence and the metal of the substrate 16 may be known to exhibit very little fluorescence. In this example embodiment, the excitation radiation 31 may be ultraviolet and/or near ultraviolet.

In some embodiments, the excitation radiation 31 may be directed to a selected target (irradiated) region of the coated component 10 or instead directed to the entirety of the coated component 10. In many embodiments, the selected target irradiated region may be significantly larger than either a nominal dimension d of a micro-crack 21 and/or the area of inspection 44. It is to be understood that if the coated component 10 is without micro-flaws 21, the excitation radiation 31 may excite a spectral response solely from the coating 18.

FIG. 4 presents a graphical representation of fluorescent count (FC) as may be determined from a reading generated by the analyzer 34 versus a range of wavelengths (A) of spectral response for a particular example of a coated substrate 16 (or coated component 10) being subjected to the excitation radiation 31 from the source 30. In various embodiments, a range of wavelength of the (filtered) excitation radiation 31 may be selected such that it has a capacity to cause the coating 18 to fluoresce (line C in FIG. 4) to a substantially greater extent than the metal substrate 16 (line S in FIG. 4) at the selected range of analyzed wavelength 60, such as by way of several factors or more. Sufficient differences may be achievable with example embodiments of the coated component 10, wherein the substrate 16 may be steel and the coating 18 may be polymeric.

Referring now also to FIGS. 2 and 7, in some embodiments, in operation of the inspection station 24, a drive mechanism 42 may be operated to move the sample coated component 10 relative to the microscope objective 32 (either automatically or by command of the operator) such that the area of inspection 44 moves along a selected (irradiated) portion of the sample coated component 10, such as from point A to point B and to point C, etc. in FIG. 3. At point A in FIG. 3, the excitation radiation 31 may be absorbed and/or occluded (or substantially attenuated) by the presence of the coating 18, such that very little, if any, fluorescent response of the substrate 16 may be communicated to the spectral analyzer 34 when the area of inspection 44 is at or about point A. In some embodiments, the greater intensity of the spectral response of the coating 18 may overwhelm any spectral response emanating from the substrate 16, if any.

When the area of inspection 44 is moved to a location such as point B in FIG. 3, the excitation radiation 31 has been allowed to communicate directly to the exposed surface portion 48 of the substrate 16 by reason of the presence of a breaching micro-crack 21 such as shown in FIG. 1B, whereupon the substrate 16 undergoes its characteristically lesser, spectral response, which may be communicated to the analyzer 34 through the void of the micro-crack 21 and the mirrored aperture 36 in FIG. 7. In some embodiments, the spectral response of the substrate 16 may comprise little or no spectral response. Thereupon, the analyzer 34 and the processor 47 may determine the presence of a micro-crack 21 in that the output would indicate a level of intensity of the measured fluorescent response as being comparable to the predetermined spectral response of the substrate 16 as represented by the line S in FIG. 4 at or about the selected range (spectrum) of analyzed wavelength 60.

In some embodiments, the width (or diameter) of the area of inspection 44 is selected such that it is less than a nominal dimension (such as a width, length or diameter) associated with a micro-crack 21, as may be established from historical inspections of flawed sample coated substrates 15 in FIG. 3. In some embodiments, the inspection area 44 may be a fraction of the nominal dimension of the micro-crack 21, such as by way of example 3/4, 1/2, 1/3, 1/4, 1/5, etc.

Upon further movement of the area of inspection 44, such that it has arrived at point C in FIG. 3, the layer 18 is again interposed between the excitation radiation 31 and the substrate 16, causing again, as at point A, for the spectral response to be analyzed and measured (by the analyzer 34 and the processor 47) to have an intensity comparable to that of the peaked portion of the line C in FIG. 4 at or about the selected range of analyzed wavelength 60, which may be used to indicate an absence of a micro-crack 21.

Referring now to FIG. 5, according to an example embodiment, an inspection area 44 of an inspection station 24 may be moved through a series of positions E, F and G along an irradiated (target) region of the coated component 10, in much the same manner as discussed above with reference to FIG. 3. At the location E, the area of inspection 44 may be superposed over an unflawed portion of the coating 18 so that the output of the spectral analyzer 34 may compare with the peaked portion of line C in FIG. 6 at or about the selected range of analyzed wavelength 60, as previously explained with reference to FIG. 4. Optionally, the processor 47 may be programmed to compare a measured fluorescent response to a threshold H established adjacent the peaked portion of line C in FIG. 6 such that a measured fluorescent response above the threshold H may indicate that the location may be free of micro-cracks 21.

In other circumstances, a discovered flaw 62 at the surface of the coating 18 may comprise a region 64 of insufficient depth to breach the coating 18, in which case the fluorescent count may take on the character of line N in FIG. 6. Optionally, the processor 47 may be programmed to compare such a measured response from analyzer 34 with respect to the region 64 to an intermediate threshold H′ such that a measured response above the intermediate threshold H′ may be used to indicate that the region 64 may be a non-breaching flaw 23 such as shown at location Y in FIG. 1B.

However, in other circumstances, when area of inspection 44 is moved further across the region 64 into a sub-region 64a (such as from the location F to the location G in FIG. 5) the spectral response may be further reduced such as represented by line G in FIG. 6. The processor 47 may be programmed to compare such a measured low response with respect to the region 64a to a lower threshold H″ such that a measured response above the lower threshold H″ may be used to indicate that the sub-region 64a may still be characterized as a deeper, but non-breaching flaw 23′ such as shown at location Z in FIG. 1B.

It is believed that the reduced levels of measured spectral response as represented by lines N and G in FIG. 6 may be a result of there being reduced amounts of substrate at the respective inspection areas 44 at locations F and G.

Returning to FIG. 6, if instead, the spectral response at the area of inspection 44 when located at the location G is below a threshold H″ and/or comparable to the spectral response of the substrate 16 (as represented by the line S in FIG. 6), the sub-region 64a may be considered to include a micro-crack 21 that breaches the substrate 18, and optionally, also that the measured response at location F (adjacent to but outside of the sub-region 64a) may be considered indicative of a rim portion of the detected micro-crack 21.

It is envisioned that the area under each of the curves C, N and G (and other such curves) may be utilized by the processor 47 to derive actual or relative values of fluorescent energies for each of the spectral (fluorescent) responses represented by the curves C, N and G. The magnitude of the fluorescent energies may be correlated by the processor 47 to derive actual or relative thicknesses of the coating 18 at the respective areas of inspection 44.

In some embodiments, one or more of the above described comparisons to the thresholds H, H′ and/or H″ may be utilized as an indicator of whether additional inspection areas 44 should be inspected for a presence or absence of micro-cracks 21.

Certain embodiments detect a presence of micro-cracks 21 in a coating 18 of a substrate 16 in a nondestructive, noninvasive manner. Some embodiments may also provide a capacity to discern whether a suspected micro-flaw is in the nature of a micro-crack 21, which breaches the coating 18, or constitutes a micro-flaw 23 short of a breach. The latter capacity may be useful to avoid false rejections.

Some embodiments may also generate effective feedback for use in the course of designing and/or redesigning a metal packaging component to avoid excessive stresses that might otherwise induce formation of micro-cracks 21. For example, should a particular folded region of the coated substrate be a locus of detected micro-cracks, the folded region might be redesigned to present a shallower or more rounded fold and/or the folding (stamping) action at the forming station 22 might be executed in stages or include a treatment to relieve stress in the coated substrate. In addition or in lieu thereof, a coating operation at a coating station 14 may be modified to apply additional coating material where needed.

Certain embodiments may provide detection of microcracks in a coated substrate without having to add a fluorescent agent or otherwise alter the original constituents comprising the coating and/or the substrate to enable the detection. Accordingly, in these embodiments the detection may be performed with the coated piece remaining in its original condition, i.e., free of any fluorescing additive agents or the like.

In some embodiments, the inspection station 24 may be configured to be operative upon a predetermined difference in a reflective spectral response of the coating 18 and the substrate 16, in addition to or in lieu of analyzing a fluorescent spectral response as described above in the example embodiment.

Furthermore, in another embodiment, the inspection station 24 may be arranged to be operative upon a detected differences in hyperspectral response or multi-spectral response of the coating 18 and the substrate 16, wherein the excitation radiation 31 might comprise a wider range of wavelengths and the analyzed spectrum might comprise a wider range of wavelengths (A) than when operating upon a difference in fluorescent spectral response or a difference in reflective spectral response of the substrate 16 and the coating 18.

Non-exclusive example embodiments of apparatus and methods are further presented in the following enumerated paragraphs. It is within the scope of the present disclosure that an individual step of a method recited herein, including in the following enumerated paragraphs, may additionally or alternatively be referred to as a “step for” performing the recited action.

### PCT

PCT 1. A method of inspecting for micro-cracks in a coated piece that includes a substrate and a coating, the method comprising: generating a responsive spectral response from an area of inspection of the coated piece by irradiating at least a portion of the coated piece, the area of inspection being less than a predetermined nominal dimension of a micro-crack; and analyzing the responsive spectral response to determine whether a micro-crack exists in the coating, including by comparing the responsive spectral response to one or more predetermined spectral values to determine whether the responsive spectral response corresponds to a response associated with a substrate such as the substrate in the coated piece.

PCT 2. The method of PCT 1, wherein the responsive spectral response includes a fluorescent response, a reflective response, a multi-spectral response or a hyperspectral response.

PCT 3. The method of PCT 1 or 2, wherein the area of inspection is the same as or smaller than the portion irradiated.

PCT 4. The method of any of PCT 1-3, further comprising analyzing the responsive spectral response to determine whether a thinned condition of the coating exists by comparing the responsive spectral response to one or more predetermined spectral values corresponding to a thinned condition of the coating.

PCT 5. The method of any of PCT 1-4, wherein the analyzing includes operating a micro-spectrometer in the ultraviolet-visible-near infrared region, wherein the lesser second spectral response from the substrate is a minimal spectral response and the first spectral response from the coating is of a higher measurable spectral response.

PCT 6. The method of any of PCT 1-5, wherein the substrate comprises a steel and or the coating comprises an organic coating.

PCT 7. The method of any of PCT 1-6, wherein the coating comprises at least one polymer selected from polyester terephthalate, polypropylene, a phenolic resin or an epoxy.

PCT 8. The method of any of PCT 1-6, wherein the coating comprises an enamel coating.

PCT 9. The method of any of PCT 1-8, further comprising applying the coating upon the substrate and forming the substrate into a desired form.

PCT 10. The method of any of PCT 1-9, further comprising applying a remedial action upon detection of a micro-crack, wherein the remedial action comprises one or more of the following: application of material to close the micro-crack; thickening of the coating in a region of the micro-crack; identifying a feature of the coated piece as being associated with a concentration of stress and a detection of a micro-crack in the region and re-designing the feature such that the concentration of stress in the region of the coated piece is reduced; and/or using a more graduated forming action in the formation of the metallic substrate into the desired form.

PCT 11. The method of any of PCT 1-9, further comprising applying a remedial action upon detection of a micro-crack, wherein the remedial action comprises rejecting the coated piece from a supply of coated pieces upon detection of a micro-crack.

PCT 12. The method of any of PCT 9, wherein the desired form comprises a lid of a container for a tobacco product.

PCT 13. A method of detecting micro-cracks in a coated piece comprising a coating and a substrate, the method comprising: irradiating at least a portion of the coated piece with an excitation radiation having a capacity to cause the coating to undergo a fluorescent spectral response, and to cause the substrate to undergo a lesser second fluorescent spectral response when the substrate is irradiated upon a portion where the substrate is exposed to the excitation radiation by a presence of a micro-crack in the coating; measuring a fluorescent spectral response from the coated piece in a selected area of inspection; and analyzing the measured fluorescent spectral response to determine whether a micro-crack exists in the coating, including by comparing the measured fluorescent spectral response to one or more predetermined values to determine whether the response corresponds to a response associated with a substrate such as the substrate in the coated piece.

PCT 14. The method of PCT 13, wherein the selected area of inspection is less than a predetermined nominal dimension of a micro-crack.

PCT 15. The method of PCT 13 or 14, wherein the substrate comprises a metal and the coating comprises an organic coating.

PCT 16. The method of any of PCT 13-15, wherein the coating comprises at least one polymer selected from polyester terephthalate, polypropylene, a phenolic resin or an epoxy.

PCT 17. The method of any of PCT 13-16, wherein the coated piece comprises a lid of a container for tobacco.

PCT 18. The method of any of PCT 1-17, wherein the coated piece remains free of an addition of a fluorescing agent.

While certain example embodiments have been described and illustrated, those of ordinary skill in the art will appreciate that the inventions disclosed herein lend themselves to variations not necessarily illustrated herein.

What is claimed is:

1. A method of inspecting for micro-cracks in a coated piece that includes a substrate and a coating, the method comprising:
generating a responsive spectral response from an area of inspection of the coated piece by irradiating at least a portion of the coated piece, the area of inspection being less than a predetermined nominal dimension of a micro-crack; and
analyzing the responsive spectral response to determine whether a micro-crack exists in the coating, including by comparing the responsive spectral response to one or more predetermined spectral values to determine whether the responsive spectral response corresponds to a response associated with a substrate such as the substrate in the coated piece.

2. The method of claim 1, wherein the responsive spectral response includes a fluorescent response, a reflective response, a multi-spectral response and/or a hyperspectral response.

3. The method of claim 1, wherein the area of inspection is the same as the portion irradiated.

4. The method of claim 1, wherein the area of inspection is smaller than the portion irradiated.

5. The method of claim 1, wherein the area of inspection is a fraction of the predetermined nominal dimension.

6. The method of claim 1, wherein the substrate is metallic and the coating is operative to abate oxidation of the metallic substrate.

7. The method of claim 1, wherein the comparison includes comparing levels of spectral count.

8. The method of claim 7, further comprising analyzing the responsive spectral response to determine whether a thinned condition of the coating exists by comparing the responsive spectral response to one or more predetermined spectral values corresponding to a thinned condition of the coating.

9. The method of claim 1, wherein the analyzing includes operating a micro-spectrometer in the ultraviolet-visible-near infrared region.

10. The method of claim 1, further comprising analyzing the responsive spectral response to detect an edge portion of a micro-crack by comparing the responsive spectral response to one or more predetermined spectral values corresponding to an edge portion of a micro-crack.

11. The method of claim 1, wherein the substrate comprises a steel.

12. The method of claim 1, wherein the coating comprises an organic coating.

13. The method of claim 1, wherein the coating comprises an enamel coating.

14. The method of claim 1, wherein the coating comprises at least one polymer selected from polyester terephthalate, polypropylene, a phenolic resin or an epoxy.

15. The method of claim 1, further comprising applying the coating upon the substrate and forming the substrate into a desired form.

16. The method of claim 15, wherein the forming includes metal stamping, metal embossing, or both.

17. The method of claim 15, wherein the desired form comprises a lid of a container for a tobacco product.

18. The method of claim 15, wherein the applying includes bonding, spraying, brushing and/or bathing.

19. The method of claim 1, further comprising applying a remedial action upon determining that a micro-crack exists.

20. The method of claim 19, wherein the remedial action includes an application of additional coating to cover the micro-crack or a thickening of the coating or both.

21. The method of claim 1, wherein the coated piece remains free of an addition of a fluorescing agent.

22. The method of claim 19, wherein the remedial action comprises:
identifying a feature of the coated piece as being associated with a concentration of stress in the region; and
re-designing the feature such that the concentration of stress in the region of the coated piece is reduced.

23. The method of claim 19, wherein the remedial action includes using a more graduated forming action when forming the substrate or the coated piece.

24. The method of claim 19, wherein the remedial action includes rejecting the coated piece from a supply of coated pieces.

25. A method of detecting micro-cracks in a coated piece comprising a coating and a substrate, the method comprising:
irradiating at least a portion of the coated piece with an excitation radiation having a capacity to cause the coating to undergo a fluorescent spectral response, and to cause the substrate to undergo a lesser second fluorescent spectral response when the substrate is irradiated upon a portion where the substrate is exposed to the excitation radiation by a presence of a micro-crack in the coating;
measuring a fluorescent spectral response from the coated piece in a selected area of inspection; and
analyzing the measured fluorescent spectral response to determine whether a micro-crack exists in the coating, including by comparing the measured fluorescent spectral response to one or more predetermined values to determine whether the response corresponds to a response associated with a substrate such as the substrate in the coated piece.

26. The method of claim 25, wherein the selected area of inspection is less than a predetermined nominal dimension of a micro-crack.

27. The method of claim 25, wherein the substrate comprises a metal and the coating comprises an organic coating.

28. The method of claim 25, wherein the coating comprises at least one polymer selected from polyester terephthalate, polypropylene, a phenolic resin or an epoxy.

29. The method of claim 25, wherein the coated piece remains free of an addition of a fluorescing agent.

30. A method of inspecting a coated metallic container component, the coated metallic container component comprising a metallic substrate and a protective coating, the method comprising:
irradiating at least a portion of the coated component with a selected radiation having a capacity to cause the coating to undergo a first spectral response, and to cause the substrate to undergo a lesser second spectral response when the substrate is irradiated upon a portion where the substrate is exposed to the radiation by a presence of a micro-flaw in the coating of sufficient depth to establish a breach in the protective layer;
measuring a spectral response from the coated component in a selected area of inspection; and
analyzing the measured spectral response to determine whether a micro-flaw exists of sufficient depth to establish a breach in the protective layer, including by determining that the measured spectral response falls below a predetermined threshold.

31. The method of claim 30, further comprising inspecting an additional inspection area upon a determination that the measured spectral response falls below the predetermined threshold.

32. The method of claim 31, wherein the inspection of an additional inspection area includes a rim portion of a micro-flaw.

33. The method of claim 30, wherein the responsive spectral response includes a fluorescent response, a reflective response, a multi-spectral response and/or a hyperspectral response.

34. The method of claim 30, wherein the selected area of inspection is less than a predetermined nominal dimension of a micro-flaw.

35. The method of claim 30, wherein the protective coating comprises an organic coating.

36. The method of claim 30, wherein the coated metallic container component remains free of an addition of a fluorescing agent.
